(19) United States
(12) Patent Application Publication
(10) Pub. No.: US 2007/0047741 A1
(43) Pub. Date: Mar. 1, 2007

(54) HEAD-UNIT LOADING DEVICE OF VEHICLE AUDIO/VIDEO SYSTEM

(76) Inventors: Yun Je Lim, Icheon-shi (KR); Jeoung Kwan Cho, Icheon-shi (KR); Dong Il Kim, Icheon-shi (KR)

Correspondence Address: IPLA P.A., 3580 WILSHIRE BLVD., 17TH FLOOR, LOS ANGELES, CA, 90010, US

(21) Appl. No.: 11/428,327

(22) Filed: Jun. 30, 2006

(30) Foreign Application Priority Data
Aug. 23, 2005 (KR) 10-2005-0077147`

(51) Int. Cl. H04B 1/00

(52) U.S. Cl. 381/86

(57) ABSTRACT

A head-unit loading device of a vehicle A/V (audio/video) system is provided. The device includes: a head unit monitor; shafts protruded from both sides of the head unit monitor; inner spring holders inserted to ends of the shafts, respectively; springs inserted to the shafts and held at their one ends by inner surfaces of the inner spring holders; outer spring holders inserted to the ends of the shafts, respectively, and inserted at their smaller diameter ends to the other ends of the springs; and trim plates having guide grooves provided at their mutual corresponding inner surfaces and inserting larger diameter ends of the outer spring holders thereinto, respectively.

### BACKGROUND OF THE INVENTION

1. Field of the Invention

The present invention relates to a vehicle audio/video system, and more particularly, to a head-unit loading device of a vehicle audio/video (A/V) system.

2. Description of the Related Art

In general, a vehicle audio/video system is an electronic equipment for listening to music and a radio station and watching a video within a vehicle. The vehicle A/V system includes a monitor for outputting the video.

FIG. 1 illustrates a construction of a head-unit loading device of a conventional vehicle A/V system. As shown in FIG. 1, the head-unit loading device 100 includes a head unit monitor 110, guide shafts 120 installed at both sides of the head unit monitor 110, and trim plates 130 having guide grooves 132 which the guide shafts 120 are inserted into and moved in.

The head unit monitor 110 is moved back and forth when a mode is changed. At this time, the guide shafts 120 guide movement of the head unit monitor 110 within the guide grooves 132 of the trim plates 130.

However, the conventional head-unit loading device 100 has a drawback in that the guide shaft 120 does not have a function of buffing, thereby causing a noise due to a design tolerance and a manufacture tolerance when the head unit monitor 110 is moved, or an end of the guide shaft 120 is fitted into the groove 132, thereby stopping the movement of the head unit monitor 110.

### SUMMARY OF THE INVENTION

Accordingly, the present invention is directed to a head-unit loading device of a vehicle audio/video system that substantially overcomes one or more of the limitations and disadvantages of the conventional art.

One object of the present invention is to provide a head-unit loading device of a vehicle audio/video system, for preventing noise occurrence when a head unit monitor is moved, and allowing the head unit monitor to smoothly move without stop.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a head-unit loading device of a vehicle A/V (audio/video) system, the device including: a head unit monitor; shafts protruded from both sides of the head unit monitor; inner spring holders inserted to ends of the shafts, respectively; springs inserted to the shafts and held at their one ends by inner surfaces of the inner spring holders; outer spring holders inserted to the ends of the shafts, respectively, and inserted at their smaller diameter ends to the other ends of the springs; and trim plates having guide grooves provided at their mutual corresponding inner surfaces and inserting larger diameter ends of the outer spring holders thereinto, respectively.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a head-unit loading device of a conventional vehicle audio/video (A/V) system;

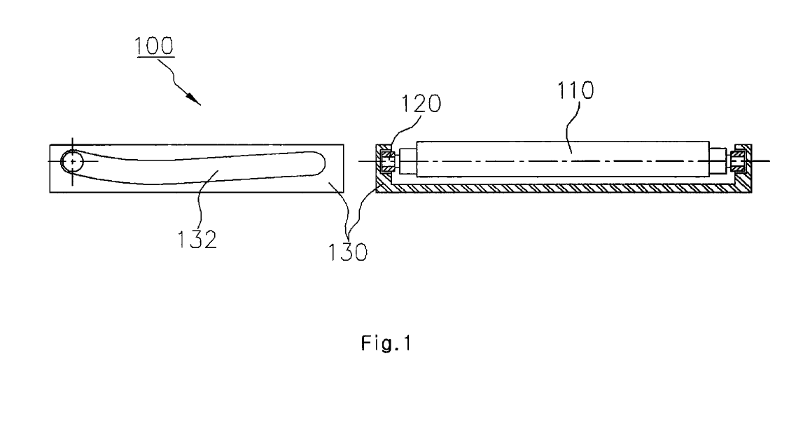

FIG. 2 illustrates a construction of a head-unit loading device of a vehicle A/V system according to a preferred embodiment of the present invention; and

FIG. 3 is a partial and magnification view illustrating a head-unit loading device of a vehicle A/V system according to a preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

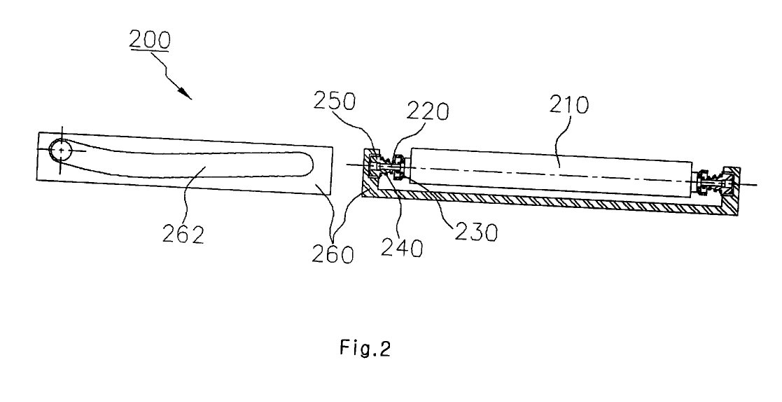

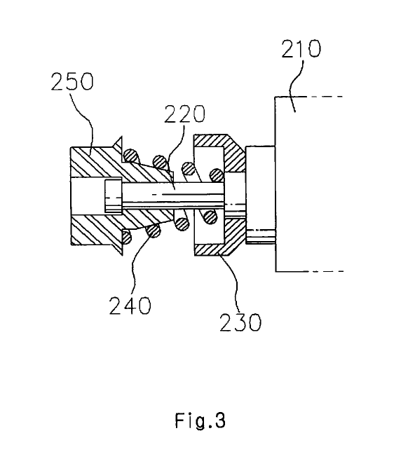

FIG. 2 illustrates a construction of a head-unit loading device of a vehicle audio/video (A/V) system according to a preferred embodiment of the present invention, and FIG. 3 is a partial and magnification view illustrating the head-unit loading device of the vehicle A/V system according to a preferred embodiment of the present invention.

As shown in FIGS. 2 and 3, the inventive head-unit loading device 200 includes a head unit monitor 200, shafts 220, inner spring holders 230, springs 240, outer spring holders 250, and trim plates 260.

(1) Head Unit Monitor

The head unit monitor 210 outputs a video and, when being set by a user to be in a video output mode, it moves to be at a predetermined position.

(2) Shaft

The shafts 220 are shaft type members protruded from both sides of the head unit monitor 210, respectively. The shaft 220 is inserted at its end into the inner spring holder 230, the spring 240, and the outer spring holder 250, respectively.

(3) Inner Spring Holder

The inner spring holder 230 is a member inserted to the end of the shaft 220. The inner spring holder 230 is inserted to an innermost of the shaft 220, and holds one end of the spring 240.

(4) Spring

The spring 240 is an elastic member for buffing when the head unit monitor 210 is moved. The spring 240 is inserted to the shaft 220, such that the spring 240 is held at its one end by an inner surface of the inner spring holder 230 and is inserted at the other end to a smaller diameter end of the outer spring holder 250. The spring 240 is a conical type spring increasing in diameter as going from one end to the other end, thereby preventing a mutual intervention when compressed. The spring 240 is compressed or tensioned depending on a movement state of the head unit monitor 210 such that the head unit monitor 210 is smoothly moved without noise and intervention.

(5) Outer Spring Holder

The outer spring holder 250 holds the spring 240 together with the inner spring holder 230. Each outer spring holder 250 is inserted to the end of the shaft 220, and is inserted at its smaller diameter end into the other end of the spring 220.

(6) Trim Plate

The trim plate 260 is a structure member having a guide groove 262 for guiding movement of the head unit monitor 210. The trim plates 260 have the guide grooves 262 at their mutual corresponding inner surfaces, respectively, and the guide groove 262 is inserted to a larger diameter end of the outer spring holder 250.

As described above, the inventive head-unit loading device of the vehicle A/V system has an effect of, when the head unit monitor is moved, preventing the noise caused by a mutual action of the inner spring holder, the spring, and the outer spring holder, and smoothly moving the head unit monitor without the stop.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A head-unit loading device of a vehicle A/V (audio/video) system, the device comprising:
a head unit monitor;
shafts protruded from both sides of the head unit monitor;
inner spring holders inserted to ends of the shafts, respectively;
springs inserted to the shafts and held at their one ends by inner surfaces of the inner spring holders;
outer spring holders inserted to the ends of the shafts, respectively, and inserted at their smaller diameter ends to the other ends of the springs; and
trim plates having guide grooves provided at their mutual corresponding inner surfaces and inserting larger diameter ends of the outer spring holders thereinto, respectively.

2. The device according to claim 1, wherein the spring is a conical type spring increasing in diameter as going from one end to the other end.
